(19) United States
(12) Patent Application Publication
(10) Pub. No.: US 2022/0249980 A1
(43) Pub. Date: Aug. 11, 2022

(54) SEGMENTATION CHROMATOGRAPHIC PURIFICATION OF CANNABINOIDS FROM CANNABIS STAIVA AND OTHER MARIJUANA BIOMASS

(71) Applicant: Trevor Percival Castor, Arlington, MA (US)

(72) Inventor: Trevor Percival Castor, Arlington, MA (US)

(73) Assignee: Trevor P. Castor, Woburn, MA (US)

(21) Appl. No.: 17/537,426

(22) Filed: Nov. 29, 2021

Related U.S. Application Data
(60) Provisional application No. 63/118,961, filed on Nov. 29, 2020.

(51) Int. Cl. B01D 15/18; B01D 15/42

(52) U.S. Cl. CPC B01D 15/1871; B01D 15/426

(57) ABSTRACT

This invention relates to methods of separating and purifying cannabinoids such as CBD, CBDA, Δ9-THC (THC), Δ9-THCA (THCA), CBN, CBG and others extracted from Cannabis sativa and other Marijuana biomass. These methods employ the use of segmentation chromatographic purification to establish purities in excess of 98.5%.

### GOVERNMENT SUPPORT

Research leading to this invention was in part funded by the National Institute on Drug Abuse and the National Cancer Institute, National Institutes of Health, Bethesda, Md., USA.

### FIELD OF THE INVENTION

This invention relates to methods for making and separating cannabinoids from Cannabis sativa and other Marijuana biomass. The methods feature supercritical, critical and near-critical fluids with and without polar cosolvents, and a multi-column chromatographic system.

### BACKGROUND OF THE INVENTION

The legitimate use of marijuana for several medical indications has far outpaced the medical and clinical evaluation of marijuana and specific cannabinoids for different medical uses. In 1997, the National Institutes of Health convened an Ad Hoc Expert Panel to discuss current knowledge of the medical uses of Cannabis. The report discussed the importance of other cannabinoids and their potential interaction effects upon THC, stating: “Varying proportions of other cannabinoids, mainly cannabidiol (CBD) and cannabinol (CBN), are also present in Cannabis, sometimes in quantities that might modify the pharmacology of THC or cause effects of their own. CBD is not psychoactive but has significant anticonvulsant, sedative, and other pharmacological activity likely to interact with THC.” The Institute of Medicine (IOM, 1999) concluded that scientific data indicate the potential therapeutic value of cannabinoid drugs, primarily Δ9-THC, for pain relief, control of nausea and vomiting, and appetite stimulation and clinical trials of cannabinoid drugs for symptom management should be conducted.

Medical marijuana is now approved in 36 states and the District of Columbia for several medical conditions such as cachexia, cancer, chronic pain, epilepsy and other disorders characterized by seizures, glaucoma, HIV, AIDS, Multiple Sclerosis, muscle spasticity and nausea. Progress has been made on several fronts on the use of cannabinoids for medical use such as Charlotte's Web (CW) being used for childhood epilepsy through ad hoc development by patient advocacy groups. Sativex® (GW Pharmaceuticals, England), a drug containing equal proportions of Δ9-THC and CBD, was recently approved as a second-line treatment for Multiple Sclerosis (MS) associated spasticity in Canada, New Zealand and 8 European countries.

The FDA has approved Epidiolex® (GW Pharmaceuticals, England), which contains a purified form of the drug substance cannabidiol (CBD) for the treatment of seizures associated with Lennox-Gastaut syndrome or Dravet syndrome in patients 2 years of age and older. The ready availability of pharmaceutical-grade CBD and a standardized CW product, manufactured following cGMP guidelines, will facilitate clinical evaluation by NIH investigators and other researchers for epilepsy, MS and other CNS diseases. The developed process will also be utilized for the manufacturing of Δ9-THC, already in use for cancer pain and nausea and AIDS-related cachexia, and other cannabinoids in development.

This invention is for the extraction, separation, purification and manufacturing of pharmaceutical-grade CBD and other cannabinoids for clinical evaluation by the NIH and other pharmaceutical companies for Multiple Sclerosis and other CNS diseases, and a standardized Charlotte's Web (CW) product for use by medical marijuana dispensaries in Massachusetts and other states for childhood epilepsy.

### SUMMARY OF THE INVENTION

Embodiments of the present invention are directed to methods of separating and purifying cannabinoids such as CBD, CBDA, Δ9-THC (THC), Δ9-THCA (THCA), CBN, CBG and others extracted from Cannabis sativa and other Marijuana biomass. These methods employ the use of segmentation chromatographic purification. Hereinafter, these methods are referred to as SCP.

As a further aspect of the invention, a mixture of cannabinoids is first extracted from Cannabis sativa biomass utilizing SuperFluids™ or organic solvent and the cannabinoid extract is deposited onto a solid phase or pumped onto a loading column.

In an embodiment of this invention, the downstream chromatographic purification will utilize a 5-column, reversed-phase chromatographic system consisting of a loading column (#1), a guard column (#2), two separation columns (#3 and #4) for isolating closely related elutants and a mobile phase solvent purification column (#5) for removing impurities prior to recycling the mobile phase.

Preferably, as the target compounds move from column 1 to columns 2, 3 and 4, fast-movers move to column 5. Column 5 is used to trap the fast movers, thus providing fresh solvent for the recycle. Eventually, the target compounds are moved to column 4 leaving the faster-moving compounds on column 5 and the slower-moving compounds on columns 1, 2, and 3. Column 4 is eluted to yield purified fractions of the target compound.

These and other features and advantages will be apparent to those skilled in the art upon reading the detailed description and viewing the drawings briefly described below.

### BRIEF DESCRIPTION OF THE DRAWINGS

FIG. 1 depicts a Five-Column Segmentation Chromatography System;

FIG. 2 shows Log (k) vs. Methanol for Cannabinoids;

FIG. 3 depicts a Standard Regression Curve for CBD (cannabidiol);

FIG. 4 depicts a Standard Regression Curve for Δ9-THC (Δ9-tetrahydrocannabinol);

FIG. 5 depicts a Standard Regression Curve for Δ9-THCA (Δ9-tetrahydrocannabinolic acid);

FIG. 6 depicts a Standard Regression Curve for CBN (cannabinol);

FIG. 7 shows the Segmentation Chromatographic Separation of Δ9-THC, Δ9-THC and CBN on CG-71;

FIG. 8 shows an HPLC Chromatogram of Δ9-THC [TT-38-C2-F4];

FIG. 9 shows an HPLC Chromatogram of Δ9-THCA [TT-10-21-03];

FIG. 10 shows the results of CBD-II-92 Comparing Relative Purity (%) and Cannabinoid Content (mg) by Fraction Number.

FIG. 11 shows the Chromatographic Purification of Cannabinoid Fractions using a 3-Column Segmentation Chromatographic Separation System:

FIG. 12 shows CBD Elution from Columns 1 and 2 in CBD-II-98-03; and

FIG. 13 shows CBD Elution from Columns 1, 2 and 3 in CBD-II-98-04.

### DETAILED DESCRIPTION OF PREFERRED EMBODIMENTS

Medical marijuana is now approved in 36 states and the District of Columbia, Guam, Puerto Rico and U.S. Virgin Islands for several medical conditions such as cachexia, cancer, chronic pain, epilepsy and other disorders characterized by seizures, glaucoma, HIV, AIDS, Multiple Sclerosis, muscle spasticity and nausea. Medical marijuana use is on the ballot in an additional states, and it is also approved for recreational use in 15 states including Massachusetts, Washington state and California. The legitimate use of marijuana for several medical indications has far outpaced the medical and clinical evaluation of marijuana and specific cannabinoids for different medical uses. In 1997, the National Institutes of Health convened an Ad Hoc Expert Panel to discuss current knowledge of the medical uses of Cannabis. The report discussed the importance of other cannabinoids and their potential interaction effects, stating: “Varying proportions of other cannabinoids, mainly cannabidiol (CBD) and cannabinol (CBN), are also present in Cannabis, sometimes in quantities that might modify the pharmacology of THC or cause effects of their own. CBD is not psychoactive but has significant anticonvulsant, sedative, and other pharmacological activity likely to interact with THC.” The Institute of Medicine (IOM, 1999) concluded that scientific data indicate the potential therapeutic value of cannabinoid drugs, primarily Δ9-THC, for pain relief, control of nausea and vomiting, and appetite stimulation and clinical trials of cannabinoid drugs for symptom management should be conducted. In 2003, NIH was awarded a United States patent for use of cannabinoids as antioxidants and neuroprotectants (Hampson et al., 2003).

Progress has been made on several fronts on the use of cannabinoids for medical use, both through rigorous clinical evaluation of Δ9-THC for cancer pain and nausea and cachexia associated with HIV/AIDS, Δ9-THC/CBD mixtures for Multiple Sclerosis and muscle spasticity, and ad hoc development by localized medical marijuana dispensaries and patient advocacy. The latter is especially true of Charlotte's Web (CW) being used for childhood epilepsy. The strain was named for 5-year-old Charlotte Figi, who had been suffering from a rare disorder called Dravet's syndrome, which caused her to have as many as 300 grand mal seizures a week. Charlotte used a wheelchair, went into repeated cardiac arrest, could barely speak and had flat-lined at least 3 times by 2012. Two years later, Charlotte is largely seizure-free and able to walk, talk and feed herself after taking oil infused with a high CBD Cannabis strain with low Δ9-THC content (CBS News, 2014).

Even with lack of well-controlled clinical evidence, families have been migrating to Colorado to seek treatment for their children. Seeds of the high-CBD hemp have migrated to other states. Recently, Utah's Governor signed “Charlee's Law,” a hemp supplement bill allowing epilepsy patients access to cannabis oils, after six-year old Charlee Jordan who suffered from Late Infant Batten Disease, a terminal inherited disorder of the nervous system that leads to seizures, and loss of vision and motor skills (The Salt Lake Tribune, 2014). More than 3 million people in North America, 6 million in Europe and 50 million worldwide have epilepsy with highest prevalence for children below five years of age and the elderly with about 30% of patients non-responsive to traditional anti-epileptic drugs (WHO, 2007). Decision Resources (FierceBiotech, 2012) projects that the epilepsy market will increase from $2.9 billion in 2011 to nearly $3.7 billion in 2016.

Sativex® (GW Pharmaceuticals, England), a drug containing equal proportions of Δ9-THC and CBD, was recently approved as a second-line treatment for Multiple Sclerosis (MS) associated spasticity in Canada, New Zealand and 8 European countries. In October 2013, the Food and Drug Administration approved clinical testing of GW Pharmaceuticals' marijuana-derived drug that is CBD-based. MS is a demyelinating and neurodegenerative disease of the CNS, which is one of the main causes of irreversible neurologic disability in young adults. MS is notoriously heterogeneous in terms of its clinical manifestations and evolution, as well as in terms of its immunopathological substrates. The disease affects 2.5 million people worldwide, of which 400,000 are in the USA and 500,000 in the EU. According to the Cleveland Clinic, MS-related health care costs are thought to be over $10 billion per year in the United States. Despite being the most common human primary demyelinating disease of the CNS, there is no satisfactory treatment as yet for MS, and there is a clear need for the development of agents able to treat this progressive disorder.

The development of a manufacturing process for cannabinoid pharmaceuticals such as CW and CBD is significant because they could be used for studying the physiological effects and the therapeutic value of cannabinoids in humans, potentially leading to new therapeutic agents that could benefit a number of patients. The ready availability of pharmaceutical-grade CBD and a standardized CW product, following cGMP guidelines, will facilitate clinical evaluation by NIH investigators and other researchers for epilepsy, MS and other CNS diseases. The developed process can also be utilized for the manufacturing of Δ9-THC, already in use for cancer pain and nausea and AIDS-related cachexia, and other cannabinoids in development.

Aspects of the present invention employ materials known as supercritical, critical or near-critical fluids. A material becomes a critical fluid at conditions which equal its critical temperature and critical pressure. A material becomes a supercritical fluid at conditions which equal or exceed both its critical temperature and critical pressure. The parameters of critical temperature and critical pressure are intrinsic thermodynamic properties of all sufficiently stable pure compounds and mixtures. Carbon dioxide, for example, becomes a supercritical fluid at conditions which equal or exceed its critical temperature of 31.1° C. and its critical pressure of 72.8 atm (1,070 psig). In the supercritical fluid region, normally gaseous substances such as carbon dioxide become dense phase fluids which have been observed to exhibit greatly enhanced solvating power. At a pressure of 3,000 psig (204 atm) and a temperature of 40° C., carbon dioxide has a density of approximately 0.8 g/cc and behaves much like a nonpolar organic solvent, having a dipole moment of zero Debye.

A supercritical fluid displays a wide spectrum of solvation power as its density is strongly dependent upon temperature and pressure. Temperature changes of tens of degrees or pressure changes by tens of atmospheres can change a compound solubility in a supercritical fluid by an order of magnitude or more. This feature allows for the fine-tuning of solvation power and the fractionation of mixed solutes. The selectivity of nonpolar supercritical fluid solvents can also be enhanced by addition of compounds known as modifiers (also referred to as entrainers or cosolvents). These modifiers are typically somewhat polar organic solvents such as acetone, ethanol, methanol, methylene chloride or ethyl acetate. Varying the proportion of modifier allows wide latitude in the variation of solvent power.

In addition to their unique solubilization characteristics, supercritical fluids possess other physicochemical properties which add to their attractiveness as solvents. They can exhibit liquid-like density yet still retain gas-like properties of high diffusivity and low viscosity. The latter increases mass transfer rates, significantly reducing processing times. Additionally, the ultra-low surface tension of supercritical fluids allows facile penetration into microporous materials, increasing extraction efficiency and overall yields.

A material at conditions that border its supercritical state will have properties that are similar to those of the substance in the supercritical state. These so-called “near-critical” fluids are also useful for the practice of this invention. For the purposes of this invention, a near-critical fluid is defined as a fluid which is (a) at a temperature between its critical temperature (T_{c}) and 75% of its critical temperature and at a pressure at least 75% of its critical pressure, or (b) at a pressure between its critical pressure (P_{c}) and 75% of its critical pressure and at a temperature at least 75% of its critical temperature. In this definition, pressure and temperature are defined on absolute scales, e.g., Kelvin and psia. To simplify the terminology, materials which are utilized under conditions which are supercritical, near-critical or exactly at their critical point will jointly be referred to as “SuperFluids™” fluids or referred to as “SFS™.” SuperFluids™ [SFS™] can be used for the fractional extraction and manufacturing of highly purified cannabinoids.

The usual methodology for preparative separations involves simply scaling up an established analytical HPLC method. To convert from analytical to preparative chromatography, all conditions are scaled and then the loading is increased until overloading causes peaks of interest to merge together, thereby destroying the separation. This method is relatively fast, but the quantity of material that can be loaded without destroying the separation is low.

By using segmentation chromatography, a large quantity of biomass extract in an alcoholic solution, e.g. methanol, is rotary evaporated onto C18 or other solids packing to yield a pellicular coated solid in which the most non-polar hydrophobic components are at the core of the particles and the most polar—water soluble—components are on the surface. This loading could be as high as 10 to 50 times the loading used in usual preparative chromatography. Alternatively, the alcoholic extract of cannabinoids is directly pumped onto a loading column at conditions more favorable for the analytes to adsorb onto the solid phase than stay in the solution.

It is an established chromatographic principle that isocratic elutions produce better separations than gradient elutions. In Segmentation Chromatography, the initial elution is done using a low percentage of acetonitrile in water so that only the polar components on the surface of the pellicular solid phase are eluted through the column system. Thus, the column system is operating in isocratic mode and initially is only being used to chromatograph the polar components. The progression of the components through the column system is monitored using an in-line UV/VIS detector or a fast-analytical system to assay the column junctions. Then, when a component of interest has migrated to the last column in the column series, that column is stripped with a rapid solvent, e.g. methanol, gradient to yield a high concentration of a narrow band of components of nearly identical polarity. After stripping the last column, the column is regenerated with mobile phase and the process is continued with a slightly stronger mobile phase.

The fractions collected from the stripping of the last column in the series will contain high concentrations of nearly pure components. If the fractions are not pure, it is likely that a separation could be made using an orthogonal separation technique such as silica chromatography.

The procedure for Segmentation Chromatographic Purification (SCP) of cannabinoid extracts comprises the following steps.

1. Obtain a Methanolic Extract.

This may be done using supercritical extractions or by extracting the biomass with methanol or with methanol containing a low percentage of water. The supercritical extract is preferred since it is usually of higher purity than the methanol extract. The methanol extract will contain a higher proportion of polar components that contribute to lowering the purity of the extract—but are easily washed from the segmentation system as “fast movers”. Thus, the supercritical extract may not be effective for the extraction of highly polar components—but will yield a high purity extract for components of intermediate polarity.

2. Assay the Methanolic Extract.

First perform a total solids analysis on the extract. Then establish a rapid isocratic HPLC analytical method that can be used to assay the column junctions.

3. Develop a Rapid Isocratic HPLC Analytical Method.

Use a standard Phenomenex Luna 5-micron×15 cm C18 (2) column. Inject the methanolic extract using 100% ACN as the mobile phase. Then decrease the percentage of ACN in the mobile phase so that all of the major chromatographic peaks elute in less than 10 minutes. Use this chromatographic system to monitor the column junctions.

4. Load the Extract onto C18 to Make Pellicular C18.

The optimum loading to use should be determined experimentally by subjecting the packing to differing loading levels. If the loading level is too high, the pellicular layers will flow together and the loading column will plug. Different extracts will have different loading capacities. For methanolic extracts from methanol extractions, a 10% loading level (grams/100 mL of packing) is likely to result in a reasonably loaded packing. For methanolic extracts from supercritical extractions, a 5% loading level is likely to result in a reasonably loaded packing.

5. Form the Loading Slurry.

After determining an appropriate loading by testing small batches, combine an appropriate quantity of methanolic extract with the appropriate quantity of packing and rotary evaporate to dryness. Wet the pellicular C18 with minimum quantity of 10% ACN in water to form a thick slurry. The entirety of this slurry is to be poured into Column 1 of the System.

6. Construct a 3 to 5-Column Segmentation Chromatography Purification System.

Column 1-2″×25 cm Column containing Cannabinoid Coated C18 Pellicular Slurry.

Column 2-2″×15 cm 40-micron C18 Guard Column.

Column 3-2″×25 cm 40-micron C18 Separation Column.

Column 4-2″×25 cm 40-micron C18 Separation Column.

Column 5-2″×25 cm 40-micron C18 Mobile Phase Purification Column.

7. Clean the Column System.

Columns 2, 3, and 4 are to be eluted with 500 mL of methanol, 500 mL of acetone, 500 mL of methanol, 200 mL of acetonitrile, and 500 mL of 10% ACN in water.

8. Sampling Valves.

Install a high-pressure valve between columns 1 and 2 and a high-pressure valve between columns 2 and 3. Install a low-pressure valve between columns 3 and 4.

9. System Elution.

Begin the elution using 10% ACN/water. This solvent should move out the water-soluble components—but not any of the intermediate polarity components—which are likely to be the biologically active components. Assay the column junctions to see if there are any components moving through the system that might be collected by eluting Column 4. If no components of interest are in transit from Column 1 to Column 2, increase the percentage of acetonitrile in the mobile phase to produce movement of these components. Bring these components into Column 4. Then stop flow, remove Column 4 from the system and elute it.

10. Elution of Column 4. Use the Following Gradient.

A=mobile phase B=100% methanol Flow=10 mL/min Bottle time=5 minutes

| Time | A | B |
|---|---|---|
| (mins) | (%) | (%) |
| 0 | 100 | 0 |
| 50 | 0 | 100 |
| 60 | 0 | 100 |
| 72 | 100 | 0 |
| 90 | 100 | 0 |

11. Assay the Fractions Using the Rapid HPLC Method.

12. Assay Critical Fractions Using a High-Resolution Gradient.

Critical fractions can be assayed in an overnight sample set to determine the chromatographic purity of the critical fractions determined by the rapid HPLC method.

13. Increase the Percentage of Acetonitrile in the Elutant.

Continue increasing the ACN concentration in ca 5% ACN steps until all of the components of interest have been eluted from the system and are contained in the methanol fractions.

Embodiments of the present invention are directed to methods of using segmentation chromatography for purifying cannabinoids for use as a therapeutic to treat pain, opioid addiction, multiple sclerosis, Parkinson's disease, and nausea and emesis.

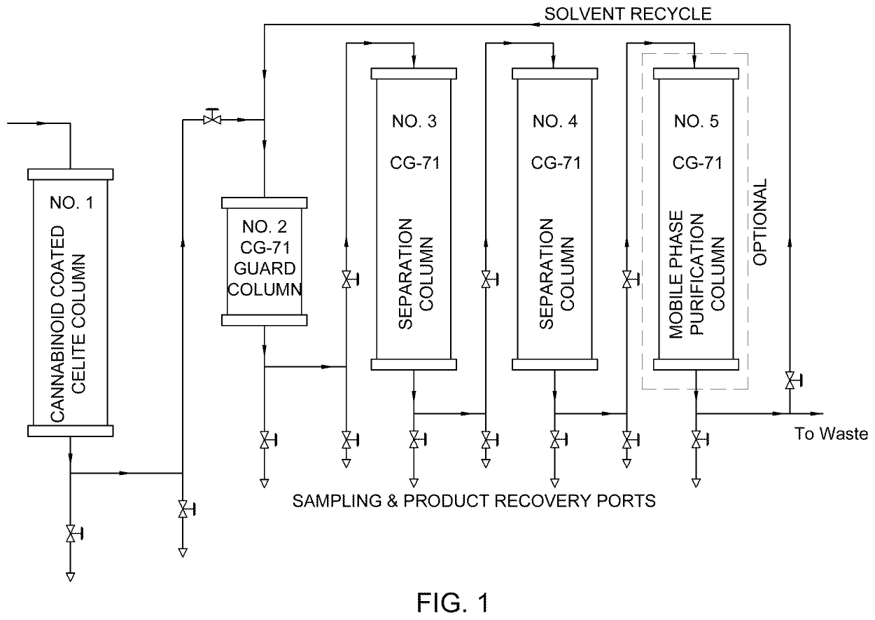

The present method and apparatus will be described with respect to FIG. 1 which depicts in schematic form the segmentation chromatographic purification of SuperFluids or organic phase extracts of Cannabis sativa and Marijuana biomass identified as 21.

The downstream chromatographic purification will utilize a 5-column, reversed-phase chromatographic system shown as FIG. 1. This system consists of a loading column (#1), a guard column (#2), two separation columns (#3 and #4) for isolating closely related elutants and a mobile phase solvent purification column (#5) for removing impurities prior to recycling the mobile phase.

As the target compounds move from column 1 to columns 2, 3 and 4, fast-movers move to column 5. Column 5 is used to trap the fast movers, thus providing fresh solvent for the recycle. Eventually, the target compounds are moved to column 4 leaving the faster-moving compounds on column 5 and the slower-moving compounds on columns 1, 2, and 3. Column 4 is eluted to yield purified fractions of the target compound.

Column Segmentation Chromatography Utilizing CG71:

Amberchrome CG-71 is a polymeric chromatographic stationary phase supplied by Tosoh Corporation, Tokyo, Japan. It is polymethylmethylacyralate and can be obtained as particles from 35 to 120 microns in diameter. It has selectivity similar to that of C18 and has a greater loading capacity than C18 since the entire particle is active, not just the surface. This material has been successfully used to separate a variety of natural products in Aphios' Natural Products Chemistry laboratory.

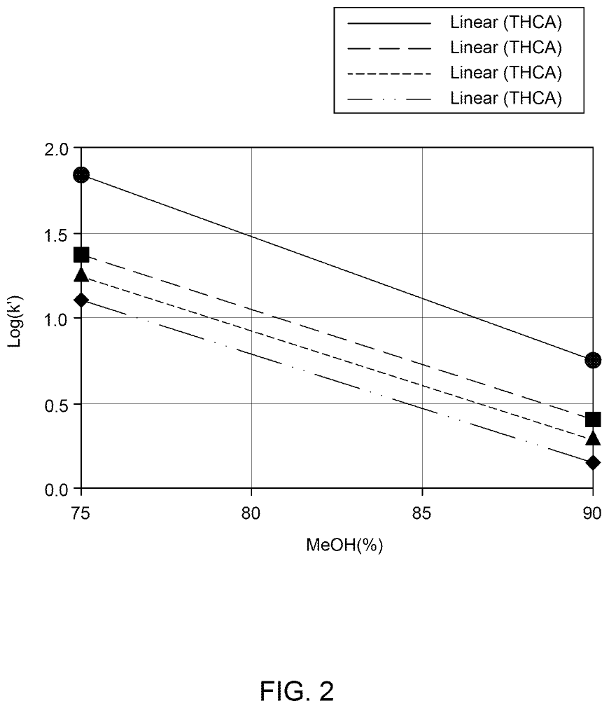

In order to design cannabinoid separation on CG-71, a standard plot of log (k′) versus % methanol as shown in FIG. 2 where k′, the retention or capacity factor, [(tᵣ−t₀)/t₀] where tᵣ is the retention time and to is the solvent front, is the selectivity index. The graph shows that CBD moves faster and is well separated from the other three major components. On C18 the elution order was found to be CBD, CBN, Δ9-THC and Δ9-THCA.

The retention time data gave a good linear response so: y=mx+b was meaningful and the “m” and “b” values could be determined for the four components. Standard chromategraphic calculations will then be made to predict the number of centimeters that a component will move down the column. The equations will then be set up in an Excel spreadsheet. Once the spreadsheet has appropriate “m” and “b” values from the graph of Log (k′) vs % methanol, different values will be entered for % methanol, flow-rate and elution time so that the migration distance can be determined under different conditions. When the system was set up with 5-cm CG-71 columns, it was found that: (a) CBD moved as predicted; (b) Δ9-THC moved as had been predicted for CBN; (c) CBN moved slightly slower than CBD.

### EXAMPLES

### Example 1: Cannabinoid Standards, HPLC Analysis and Standard Curves

Cannabinoid Standards: Four (4) standards were purchased for chromatographic assay from Alletch and ChromaDex, Santa Ana, Calif. They were all purchased at certified concentrations of 1 mg/ml in methanol and transported at ambient atmosphere in sealed glass vials. The standards are as follows:
1. Cannabidiol (CBD), C₂₁H₃₀O₂, MW=314.47 g/mol, (99.9%) [Alltech]
2. A8-THC, C₂₁H₃₀O₂, MW=314.45 g/mol, (90.0%) [Alltech]
3. Cannabinol, C₂₁H₂₆O₂ (CBN), MW=310.42 g/mol, (98.9%) [Alltech]
4. Delta-9-Tetrahydrocannabinol (Δ9-THC), C₂₁H₃₀O₂, MW=314.45 g/mol, (97%) [ChromaDex, Santa Ana, Calif.]

Under Aphios' DEA Schedule I license, we requested and obtained 5 ml of 50 mg/ml Δ9-THC in absolute (100%) ethanol for use as an analytical standard in our Phase I SBIR research protocol on 12/27/02. We also requested and obtained 5 mg of impure Δ9-THCA (Lot No. JMCross 12-6-3) from the University of Mississippi on Apr. 18, 2003. This request was made to use Δ9-THCA as a standard as our research evolved to include the isolation of the carboxylic acid of Δ9-THC.

For this research, we purchased four (4) new standards for chromatographic assay from Restek Corporation, Bellefonte, Pa. They were all purchased at certified concentrations of 1 mg/ml in methanol and transported on ice in sealed glass vials. The standards are as follows:
5. Cannabidiol (CBD), C₂₁H₃₀O₂, MW=314.47 g/mol, (99%) [Restek No. 34011, Lot No. A0103078]
6. Cannabinol (CBN), C₂₁H₂₆O₂, MW=310.42 g/mol, (99%) [Restek No. 34010, Lot No. A0106034]
7. Delta-9-Tetrahydrocannabinol (Δ9-THC), C₂₁H₃₀O₂, MW=314.47 g/mol, (99%) [Restek No. 34067, Lot No. A0107164]
8. Delta-9-Tetrahydrocannabinolic acid (Δ9-THCA), C₂₂H₃₀O₄, MW=358.47 g/mol, (99%) [Restek No. 34093, Lot No. A0106555]

HPLC Analysis: Two (2) HPLC methods were used the analysis of Δ9-THC, Δ-8-THC, CBN, CBD and Δ9-THCA. Since Δ9-THCA is the precursor of Δ9-THC via decarboxylation (heat) and CBN is the degradation (oxidative) product of Δ9-THC, both compounds must be resolved by the chromatography system. CBD is not psychotomimetic in pure form although it does have sedative, analgesic, and antibiotic properties. CBD can contribute to the psychotropic effect by interacting with Δ9-THC to potentiate (enhance) or antagonize (interfere or lessen) certain qualities of this effect. Δ9-THC is the main psychotomimetic (mind-bending) compound of Cannabis. Δ-8-THC is slightly less active and is reported in low concentrations, less than 1% of Δ9-THC, and may be an artifact of the extraction/analysis process.

The two HPLC methods used were: (1) a gradient system utilizing a modified Phenomenex method; and (2) an isocratic system that is a modification of the Maripharm, Rotterdam, Netherlands method. The latter system was selected based on peak separation and product purities. This isocratic method utilized a Phenomenex Luna 3 μm C18 column (5 cm×4.6 mm) with a pre-column at 25° C. The mobile phase, at 1.0 ml/min, consisted of 78% methanol:22% water containing 1% acetic acid. Absorbance was monitored by a Waters Photodiode Array (PDA) detector, Model 996, and measured at 285 nm and 230 nm.

The analytical HPLC system included a Waters 717 Autosampler, 600E System Controller and a Waters Dual-Piston High Pressure HPLC pump, Model No. 600, driven by a Pentium 4 Personal Computer and controlled by a Waters Millenium 4.0 software. Temperature of the HPLC column was controlled by an Eppendorf CH-30 column heater. This isocratic system was utilized to analyze the Cannabis biomass and experiments MAJ-1 to MAJ-22. In order to reduce run time for Phenomenex Luna 5 and 10 μm C18 columns, the mobile phase was changed to 80% acetonitrile:20% water containing 0.1% acetic acid at a flowrate or 2.0 ml/min and a column temperature of 30° C. with absorbance measurement at 285 nm. This isocratic system was utilized to analyze fractions from experiments MAJB-1 to MAJB-10. Also, using this isocratic system, a second HPLC system (ISCO) was utilized to monitor the column chromatography utilized in the downstream purification.

A new analytical system was utilized to develop new standard curves and analyze biomass and fractions. The new analytical system consisted of a Waters 2695 Alliance Separations Module with Waters 996 Photodiode Array Detector controlled by Empower Pro software [Aphios' cGMP material code for this equipment is APH-EQ-07120]. The Alliance HPLC system is operated following Aphios' SOP No. EQ-015.

We evaluated a third HPLC method developed by Restek Corporation for their Cannabinoid-specific HPLC column, Raptor ARC-18 (Restek No. 9314A65). The Raptor ARC-18 is a 2.7 μm, 150×4.6 mm column. This HPLC method is a gradient method that included mobile phase A (0.1% formic acid in water) and a mobile phase B (0.1% formic acid in acetonitrile) with the following gradient: 25% A::75% B from 0 to 4.0 min, 0% A:100% B from 4.0 to 4.01 min and 25% A:75% B from 4.01 to 7.0 min. The gradient was run at a combined flowrate of 1.5 mL/min, the column was held at 50° C. and detection was measured at 220 nm.

Utilizing the HPLC method suggested by Restek for analyzing cannabinoids, all of the standards eluted out pretty close to the injection peak, CBD at 1.3 mins, CBD at 1.4 mins, THC at 1.5 mins and THCA at 1.7 mins.

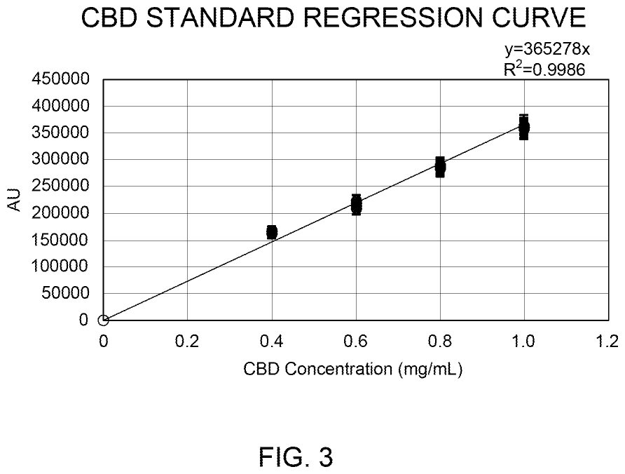

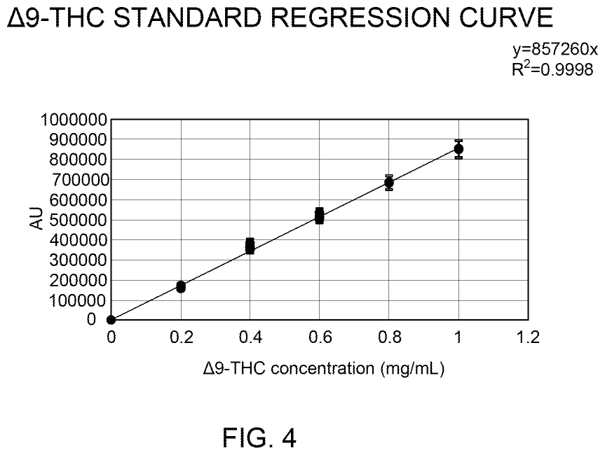

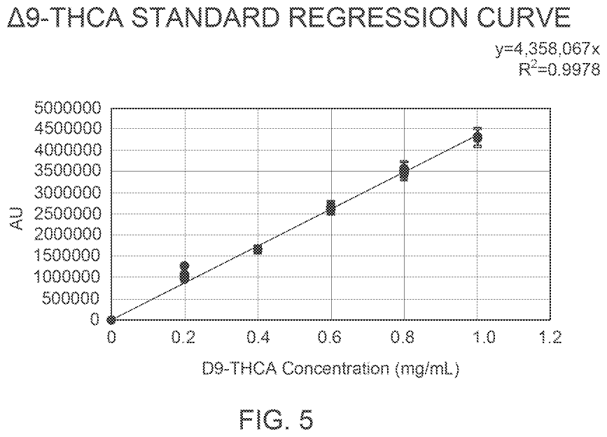

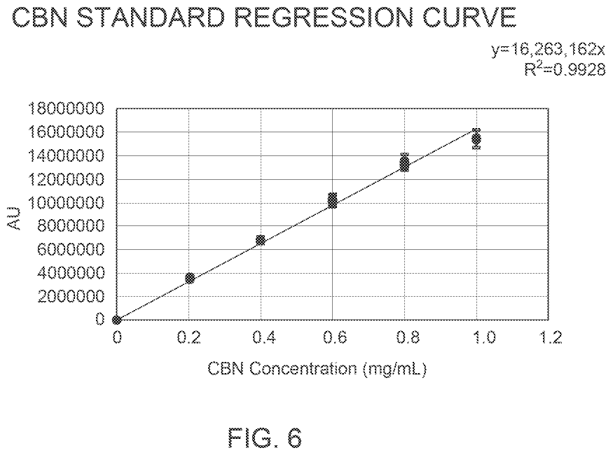

We elected to work with the modified isocratic HPLC method developed by Aphios for C18 columns. We utilized Phenomenex Luna 5 10 μm C18 column, an isocratic mobile phase of 80% acetonitrile::20% water containing 0.1% acetic acid at a flowrate or 2.0 ml/min and a column temperature of 30° C. with absorbance measurement at 285 nm. The standard regressions curves for CBD, Δ9-THC, Δ9-THCA and CBN are respectively shown in FIGS. 3, 4, 5 and 6; three sample sets the dilutions of the standards in methanol were run for each curve.

### Example 2: Column Segmentation Chromatography Utilizing CG71

Fractions from the SuperFluids™ CXP of heat-treated Cannabis saliva, MAJB-1, were extended onto 120-μm CG-71 and was packed into Column 1 of a 4-Column CG-71 system. Elution was done in recycle mode with 65% methanol and the column junctions were monitored by HPLC. When it was observed that Δ9-THC was just beginning to exit from Column 3, this column was isolated, the mobile phase was changed from 65% methanol to 75% methanol and a gradient was done from 75% methanol to 100% methanol in 100 minutes at 20 ml/minute. A fraction collector was set up to collect a fraction every 5 minutes so that each fraction would be 100 ml. Essentially all of the cannabinoids were eluted from Column 1; Column 2 contained some of the slow-moving Δ9-THCA as well as residual Δ9-THC and a peak in the CBN retention time region. Column 3 contained the main quantity of Δ9-THC, and Column 4 contained only pure Δ9-THC, which had passed the junction between Column 3 and Column 4.

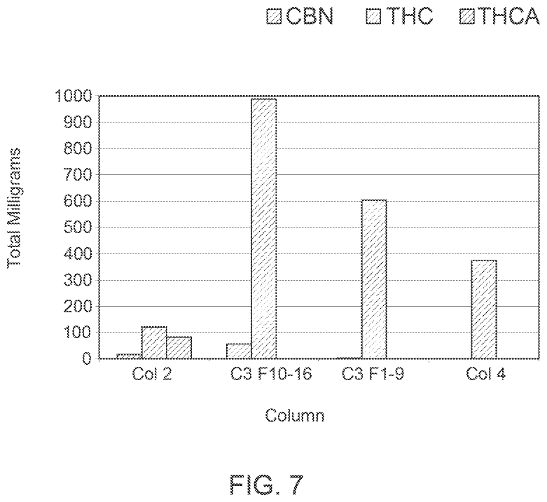

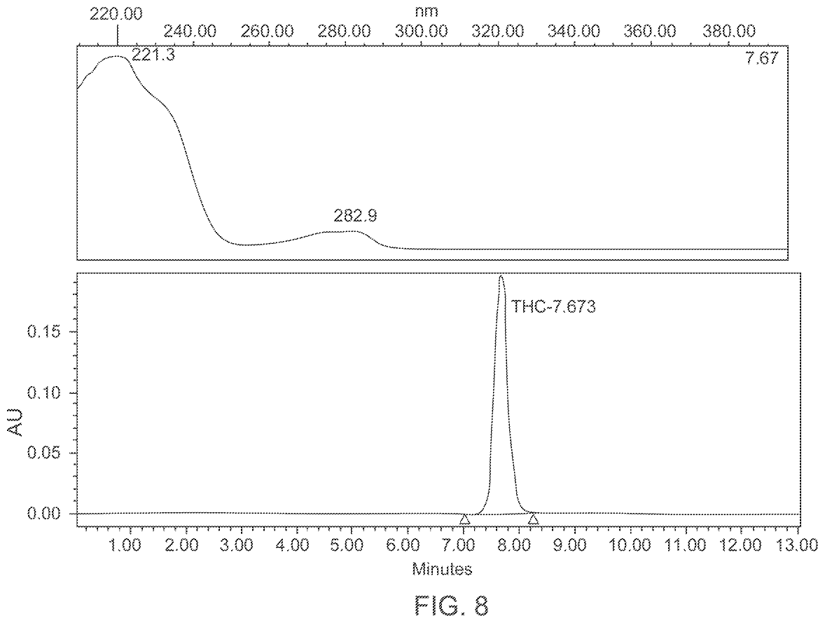

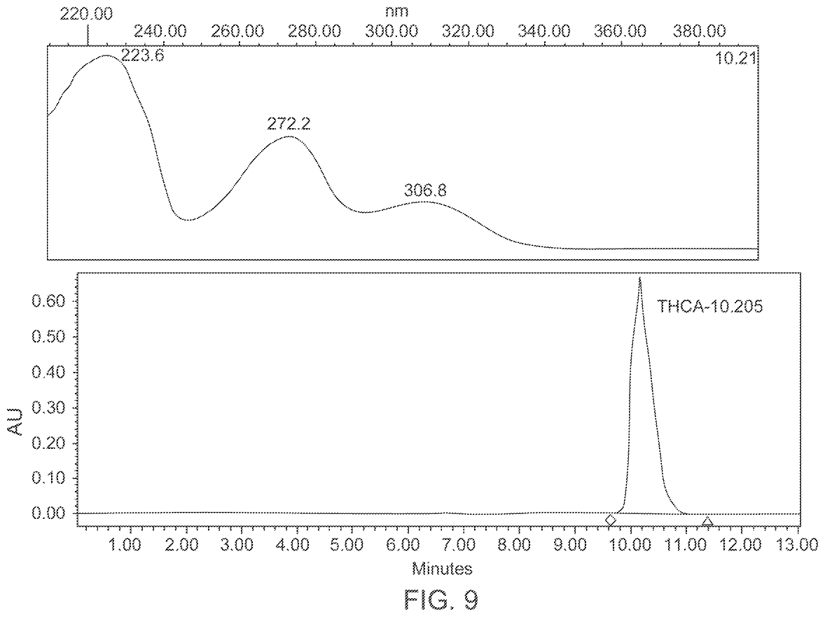

The results of the segmentation chromatographic separation of the SFS-CXP fractions of heat-treated Cannabis sativa, MAJB-1, are shown in FIG. 7. An HPLC chromatographic scan of Δ9-THC is shown as FIG. 8. The segmentation chromatographic system was also utilized to purify Δ9-THCA from the SFS-CXP fractions of untreated Cannabis sativa, MAJB-3. An HPLC chromatographic scan of Δ9-THCA is shown as FIG. 9.

A C18 (40 μm) segmentation chromatography 4-column system with a water:acetonitrile:acetic acid mobile phase was also developed and utilized for the separation of Δ9-THC from CBN, and for the polishing of high purity side-fractions. In this system, CBN was found to lead the Δ9-THC, which was opposite to the elution order found in the CG-71/methanol:water:acetic acid system.

### Example 3: Superfluids™ Extraction and Chromatographic Purification of Cannabinoids from Cannabis sativa (CBD-II-92)

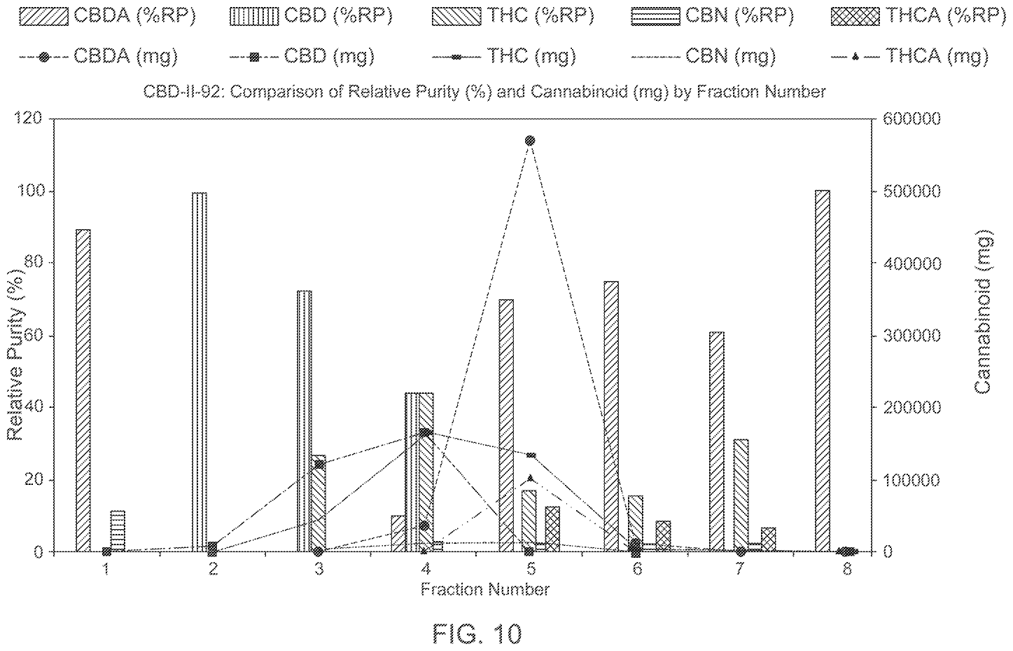

In CBD-II-92, SFS-CXP semi-works extraction and chromatographic purification of cannabinoids from high CBD content Cannabis sativa, which was first ground and dried in place with warm air at 40° C., was conducted using SFS CO₂ at 3,000 psig and 50° C. with methanol as a backpressure regulator (BPR) flush solvent in extraction step and co-solvent of CO₂ in chromatographic step with activated silica at 3,000 psig and 25° C. [This is a scale-up based on experiments CBD-I-24, CBD-II-38, CBD-II-67 and CBD-II-78, and a re-run of CBD-II-87, CBD-II-88, CBD-II-90, CBD-91]. The results of the scale-up run CBD-II-92 are shown in FIG. 10.

In CBD-II-92, all of the extracted CBD (291.5 g) was produced during the extraction step as anticipated since the neutral CBD will pass through the silica chromatography column. The first CBD fraction (6.5 g) [Fraction No. 2] had a relative purity of 99.15% and an absolute purity of 19.5% and did not contain any Δ9-THC. Fraction No. 3, the second CBD fraction, contained 120.2 g CBD with a relative purity of 72.2% and an absolute purity of 51.5% and co-eluted with 44.0 g of Δ9-THC with a relative purity of 26.4% and an absolute purity of 18.8%. Fraction No. 4, the third and largest CBD fraction, contained 164.7 g CBD and co-eluted with an equal quantity of Δ9-THC and 10.3 g CBN.

The elution of CBD and Δ9-THC was surprising and unexpected since the loaded biomass only contained CBDA (5.088%), Δ9-THCA (2.498%) and CBN (0.083%). The conversions of CBDA to CBD and Δ9-THCA to Δ9-THC were probably caused by the drying of the ground Cannabis sativa biomass with warm compressed air at 40° C., with the conversions being driven by oxidation potential. These conversions can be prevented by using warm compressed nitrogen at 40° C. or even 60° C. for in-situ drying of the ground Cannabis sativa biomass.

CBD-II-92 produced 622.4 g of CBDA with relative purities between 10% and 100%, and absolute purities between 2% and 54%. The highest yielding fraction after the start of the chromatographic step was Fraction No. 5 which contained 569.7 g CBDA with a relative purity of 69.6% and an absolute purity of 54%.

Unexpectedly, a small quantity CBDA (0.3 g) with a relative purity of 88% and an absolute purity of 2% was eluted in Fraction No. 1. This was probably caused by the SFS channeling through the silica before it was fully pressurized to operating pressure.

Small quantities of CBDA, Δ9-THC and Δ9-THCA with trace quantities of CBN were produced in the last 3 chromatographic steps, Fractions Nos. 6, 7 and 8. Thus, while most of the CBDA was eluted in a single fraction, the SFS chromatography can be improved. We anticipate that improvements can be made by better drying of the biomass and silica to remove OH⁻ from binding sites on the silica, and better control of the flowrate and composition of the SFS mobile phase.

The overall yield of CBDA and CBD was 2.55% giving a recovery efficiency of 50.1%, and the overall yield of Δ9-THCA and Δ9-THC was 1.27% giving a recovery efficiency of 50.1%. This data suggests the extraction time should be doubled from 338 minutes to 676 minutes at the operating conditions of pressure, temperature and flowrate utilized in CBD-II-92.

### Example 4: Segmentation Chromatographic Purification of SFS-CXP Fractions (CBD-II-98-03)

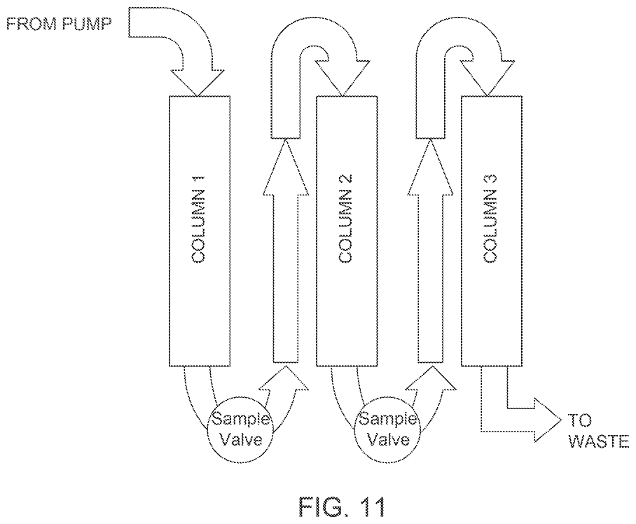

The downstream chromatographic purification utilized a 3-column, reversed-phase chromatographic system shown as FIG. 11. This system consists of a loading column (#1) and two separation columns (#2 and #3) for isolating closely related eluants. As the target compounds move from column 1 to columns 2, fast-movers move to column 3. Eventually, the target compounds are moved to column 2 leaving the faster-moving compounds on column 3 and the slower-moving compounds on column 1. Column 2 is eluted to yield purified fractions of the target compound.

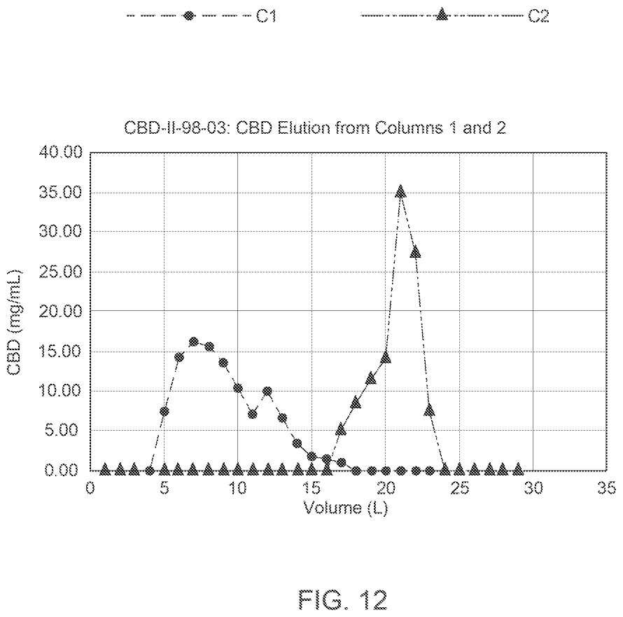

Fraction CBD-II-92-03 of Example 3 was first concentrated using a Laborota 20, 20 L Rotavap to reduce the volume from 19.8 L containing 120.2 g CBD, 2.4 g CBN and 44.0 g Δ9-THC to 2.9 L containing 121.9 g CBD, 2.8 g CBN and 47.5 g Δ9-THC; all measurements were made by HPLC in triplicate. There were no significant changes in the composition or content of the concentrated fraction. The fraction was then winterized at −80° C. and filtered to remove waxes. The composition of the fraction was then adjusted to 75% methanol and loaded onto the segmentation chromatographic system. A step-gradient was then performed from 80% to 90% to 100% methanol. The elution profile is shown in FIG. 12.

CBD-II-98-03 produced 101.43 g of 99.9% pure CBD, 0.1% CBN and 0.0% Δ9-THC. The CBN and Δ9-THC was trapped and eluted from Column 3.

### Example 5: Segmentation Chromatographic Purification of SFS-CXP Fractions (CBD-II-98-04)

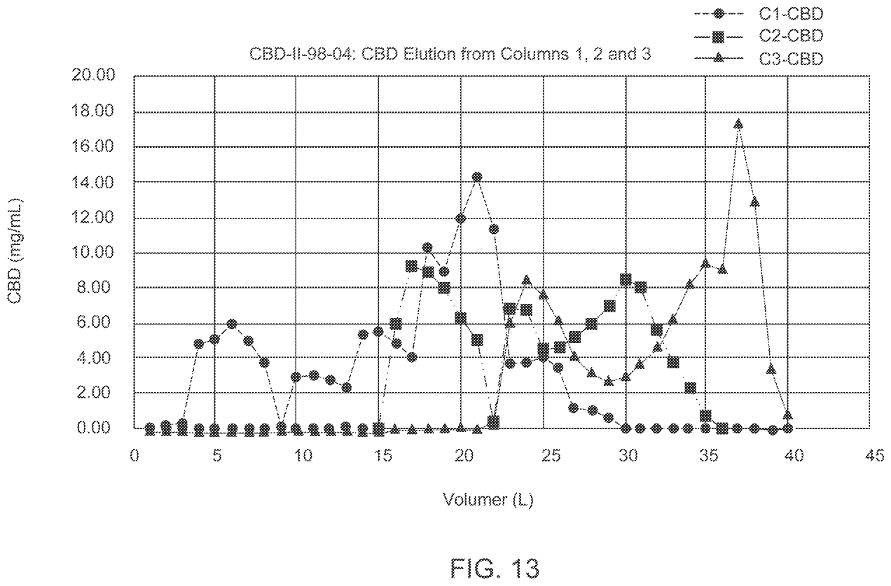

Fraction CBD-II-92-04 of Example 3 was first concentrated using a Laborota 20, 20 L Rotavap to reduce the volume from 30.0 L containing 36.0 g Δ9-CBDA, 164.8 g CBD, 10.3 g CBN and 165.9 g Δ9-THC to 4.2 L; all measurements were made by HPLC in triplicate. The fraction then was winterized by placing it in a −80° C. freezer overnight and filtering using a vacuum filtration apparatus. (#4 filter paper Whatman No. 1004-240). The winterization process was repeated two more times to remove as much of the lipid content as possible. The fraction volume was reduced to 2.7 L and contained 36.4 g CBDA, 164.0 g CBD, 9.2 g CBN, 143.1 g Δ9-THC and 21.7 g Δ9-THCA; all measurements were made by HPLC in triplicate. The composition of the fraction was then adjusted to 75% methanol and loaded onto the segmentation chromatographic system. A step-gradient was then performed from 80% to 90% to 100% methanol. The elution profile is shown in FIG. 13.

CBD-II-98-04 produced 76.05 g of 99.8% pure CBD and CBDA, 0.2% CBN and 0.0% Δ9-THC.

What is claimed is:

1. A method of making and separating compounds in a multi-column system wherein a mixture of compounds is deposited onto the head of a chromatographic loading column 1 containing a solid phase, the target compounds move from column 1 to n−1 chromatographic columns, fast-movers move to the last chromatographic column n used to trap the fast movers, the target compounds are moved to column n−1 leaving the faster-moving compounds on column n and the slower-moving compounds on remaining columns, and column n−1 is then eluted to yield purified fractions of the target compound.

2. The method of claim 1 wherein the mixture of compounds is pumped directly onto the chromatographic loading column 1.

3. The method of claim 1 wherein the purified mobile phase from column n is recycled back to 1.

4. The method of claim 1 wherein the chromatographic media consists of celite, C8, C10, C18 or silica.

5. The method of claim 1 wherein the chromatographic media is C18.

6. The method of claim 1 wherein the number of columns, n, is 5.

7. The method of claim 1 wherein the number of columns, n, is 3.

8. The method of claim 1 wherein the mixture of compounds is cannabinoids.

9. An apparatus for making and separating compounds in a multi-column system wherein a mixture of compounds is deposited onto the head of a chromatographic loading column 1 containing a solid phase, the target compounds move from column 1 to n−1 chromatographic columns, fast-movers move to the last chromatographic column n used to trap the fast movers, the target compounds are moved to column n−1 leaving the faster-moving compounds on column n and the slower-moving compounds on remaining columns, and column n−1 is then eluted to yield purified fractions of the target compound.
